(19) United States
(12) Patent Application Publication
(10) Pub. No.: US 2021/0271095 A1
(43) Pub. Date: Sep. 2, 2021

(54) OPTICAL PATH CONTROL MEMBER AND DISPLAY DEVICE COMPRISING SAME

(71) Applicant: LG INNOTEK CO., LTD., Seoul (KR)

(72) Inventors: Hyun Joon KIM, Seoul (KR); Sung Gon JUN, Seoul (KR)

(21) Appl. No.: 17/258,838

(22) PCT Filed: Jul. 5, 2019
(86) PCT No.: PCT/KR2019/008307

§ 371 Date: Jan. 8, 2021

(30) Foreign Application Priority Data
Jul. 12, 2018 (KR) 10-2018-0081303
Dec. 20, 2018 (KR) 10-2018-0166750

(51) Int. Cl. G02B 27/09; G02B 27/60; B32B 3/30

(52) U.S. Cl. CPC G02B 27/095; G02B 27/60; B32B 2307/42; B32B 2457/20; B32B 3/30

(57) ABSTRACT

An optical path control member according to an embodiment comprises: a base substrate; a resin layer which is disposed on the base substrate and includes multiple intaglio parts spaced apart from each other; and multiple pattern portions arranged inside the multiple intaglio parts and spaced apart from each other, wherein the pitch between the multiple pattern portions is shorter than or equal to 30 μm.

### TECHNICAL FIELD

Embodiments relate to an optical path control member and a display device including the same.

### BACKGROUND ART

A light-shielding film shields transmitting of light from a light source, and is attached to the front surface of a display panel which is a display device used for a mobile phone, a notebook, a tablet PC, a vehicle navigation system, a vehicle touch, etc., so that the light-shielding film adjusts a viewing angle of light according to an incident angle of light to express a clear image quality at a viewing angle needed by a user when the display transmits a screen.

In addition, the light-shielding film may be used for the window of a vehicle, building or the like to shield outside light partially to prevent glare, or to prevent the inside from being visible from the outside.

That is, the light-shielding film may control the movement path of light, shield light in a specific direction, and transmit light in a specific direction.

Meanwhile, such a light-shielding film may be applied to a display device such as a navigation system or a vehicle dashboard in a movement means such as a vehicle. That is, the light-shielding film may be applied to various fields in accordance with various purposes.

Meanwhile, in order to control the movement path of light, a plurality of patterns for converting a path of light may be formed on a transparent substrate in the light-shielding film.

When the light-shielding film including the patterns is bonded to a display panel, the pattern of the light-shielding film and the pattern of the display panel may be disposed to be overlapped with each other, and a moire phenomenon may occur by such an overlapping phenomenon.

Such a moire phenomenon may be recognized by external users, and may cause a deterioration in visibility for the users.

Therefore, there is a need for an optical path control member having a new structure capable of preventing the moire phenomenon according to a pattern.

### DISCLOSURE

### Technical Problem

An object of the embodiment is directed to providing an optical path control member having improved light blocking characteristics and capable of reducing a moire phenomenon and the like.

### Technical Solution

An optical path control member according to an embodiment includes: a base substrate; a resin layer disposed on the base substrate and including a plurality of intaglio portions spaced from each other; and a plurality of pattern portions disposed inside the plurality of intaglio portions and spaced from each other, wherein a pitch of the plurality of pattern portions is 30 μm or less.

An optical path control member according to an embodiment includes: a base substrate including a first region and a second region; a resin layer including a plurality of intaglio portions disposed on the base substrate and spaced from each other; and a plurality of pattern portions disposed inside the plurality of intaglio portions and spaced from each other, wherein the pattern portion includes a plurality of first pattern portions disposed on the first region and a second pattern portion disposed on the second region, and a first pitch of the first pattern portions is different from a second pitch of the second pattern portions.

### Advantageous Effects

An optical path control member according to embodiments may control the pitch of a pattern portion to a specific range, thereby optimally reducing moire due to overlapping phenomenon of patterns of the optical path control member and a display panel.

In addition, the optical path control member according to the embodiment may increase brightness as well as a moire reduction effect. That is, the light transmittance and the brightness in a front direction may be increased by increasing a region through which light is transmitted by a short-circuited portion of a second pattern portion.

Accordingly, when a user looks at the display device including the optical path control member from the outside, a greater amount of light may be transmitted, thereby improving visibility.

In addition, when the optical path control member is coupled to another member, a moire phenomenon due to an overlapping phenomenon of the patterns may be more effectively reduced by increasing irregularity of the pattern by arranging the short-circuited portion unevenly and forming a width and pitch of the short-circuited portions unevenly.

In addition, in the optical path control member according to the embodiment, the irregularity of the pattern may be increased by forming the pattern portion to have a plurality of directions. Accordingly, when the optical path control member is coupled to another member, the moire phenomenon due to the overlapping phenomenon of the patterns may be more effectively reduced.

In addition, the moire reduction effect and the brightness may be increased by forming an additional short-circuited portion in the pattern portion. That is, the light transmittance and the brightness in a front direction may be increased by increasing a region through which light is transmitted by a short-circuited portion of the pattern portion.

Accordingly, when the user looks at the display device including the optical path control member from the outside, a greater amount of light may be transmitted, thereby improving visibility.

In addition, the light path control member according to the embodiments may be efficiently applied in a display device that requires different light transmittances for each region.

For example, the optical path control member according to the embodiment may be applied to a vehicle. For example, an instrument panel including a display portion for displaying a speed, an engine, a navigation system, and the like, and a signal portion for displaying a warning signal, may be displayed in front of a driver's seat of the vehicle.

In this case, the display portion for displaying a speed, an engine, a navigation system, and the like is a portion in which the user acquires information by visual recognition, and the signal portion is a portion in which the user operates, and thus the display portion may be required to have a relatively larger light transmittance than the signal portion.

Accordingly, when the light transmittance of the optical path control member applied to the display portion becomes smaller than that of the optical path control member applied to the signal portion, the visibility at the display portion may be deteriorated, and unnecessary light is transmitted to the signal portion, and thus the light efficiency may be lowered.

The optical path control member according to the embodiment may be effectively applied to a display device that requires different light transmittances for each region as described above. That is, the visibility may be improved by the same amount of light emitted from a light source by increasing the light transmittance in a portion requiring high brightness and decreasing the light transmittance in a portion requiring relatively low brightness, so that the visibility and the light efficiency in each region may be improved.

That is, in a portion requiring larger brightness, the light transmittance may be increased by increasing the distance between the pattern portions or decreasing the width of the pattern portions to decrease the density of the pattern portion per unit area, and in a portion requiring smaller brightness, the light transmittance may be decreased by decreasing the distance between the pattern portions or increasing the width of the pattern portion to increase the density of the pattern portion per unit area.

That is, the optical path control member according to the embodiments may control the light transmittance according to the use environment of the display device to which the optical path control member is applied by varying the distance or the width of the pattern portion for each region, and accordingly, it is possible to improve and control the visibility of the user in each region even without an additional light source or a light-shielding member.

### DESCRIPTION OF DRAWINGS

FIG. 1 is a perspective view of an optical path control member according to a first embodiment.

FIG. 2 is an upper surface view of the optical path control member according to the first embodiment.

FIG. 3 is a cross-sectional view in which a pattern portion is not disposed in a cross-sectional view taken along line A-A′ of FIG. 2.

FIG. 4 is the cross-sectional view taken along line A-A′ of FIG. 2.

FIG. 5 is an upper surface view for describing a pattern of the optical path control member according to the first embodiment.

FIG. 6 is a graph for describing a moire phenomenon of the optical path control member according to the first embodiment and Comparative Example.

FIGS. 7 to 12 are upper surface views of an optical path control member according to another first embodiment.

FIGS. 13 to 15 are upper surface views of an optical path control member according to still another first embodiment.

FIG. 16 is a perspective view of an optical path control member according to a second embodiment.

FIG. 17 is an upper surface view of the optical path control member according to the second embodiment.

FIG. 18 is a cross-sectional view in which a pattern portion is not disposed in a cross-sectional view taken along line A-A′ of FIG. 17.

FIG. 19 is the cross-sectional view taken along line A-A′ of FIG. 17.

FIG. 20 is a view for describing positions of a first region and a second region according to the second embodiment.

FIG. 21 is a perspective view of an optical path control member according to another second embodiment.

FIG. 22 is an upper surface view of the optical path control member according to another second embodiment.

FIG. 23 is a cross-sectional view in which a pattern portion is not disposed in a cross-sectional view taken along line B-B′ of FIG. 22.

FIG. 24 is the cross-sectional view taken along line B-B′ of FIG. 22.

FIG. 25 is a cross-sectional view of a display device to which an optical path control member according to embodiments is applied.

FIG. 26 is a view describing one embodiment of a display device to which an optical path control member according to embodiments is applied.

### MODES OF THE INVENTION

Hereinafter, embodiments of the present invention will be described in detail with reference to the accompanying drawings. However, the spirit and scope of the present invention is not limited to a part of the embodiments described, and may be implemented in various other forms, and within the spirit and scope of the present invention, one or more of the elements of the embodiments may be selectively combined and replaced.

In addition, unless expressly otherwise defined and described, the terms used in the embodiments of the present invention (including technical and scientific terms) may be construed the same meaning as commonly understood by one of ordinary skill in the art to which this invention belongs, and the terms such as those defined in commonly used dictionaries may be interpreted as having a meaning that is consistent with their meaning in the context of the relevant art.

In addition, the terms used in the embodiments of the present invention are for describing the embodiments and are not intended to limit the present invention. In this specification, the singular forms may also include the plural forms unless specifically stated in the phrase, and may include at least one of all combinations that may be combined in A, B, and C when described in “at least one (or more) of A (and), B, and C”.

Further, in describing the elements of the embodiments of the present invention, the terms such as first, second, A, B, (a), and (b) may be used. These terms are only used to distinguish the elements from other elements, and the terms are not limited to the essence, order, or order of the elements.

In addition, when an element is described as being “connected”, “coupled”, or “connected” to another element, it may include not only when the element is directly “connected” to, “coupled” to, or “connected” to other elements, but also when the element is “connected”, “coupled”, or “connected” by another element between the element and other elements.

Further, when described as being formed or disposed “on (over)” or “under (below)” of each element, the “on (over)” or “under (below)” may include not only when two elements are directly connected to each other, but also when one or more other elements are formed or disposed between two elements.

Furthermore, when expressed as “on (over)” or “under (below)”, it may include not only the upper direction but also the lower direction based on one element.

Hereinafter, an optical path control member according to a first embodiment will be described with reference to drawings.

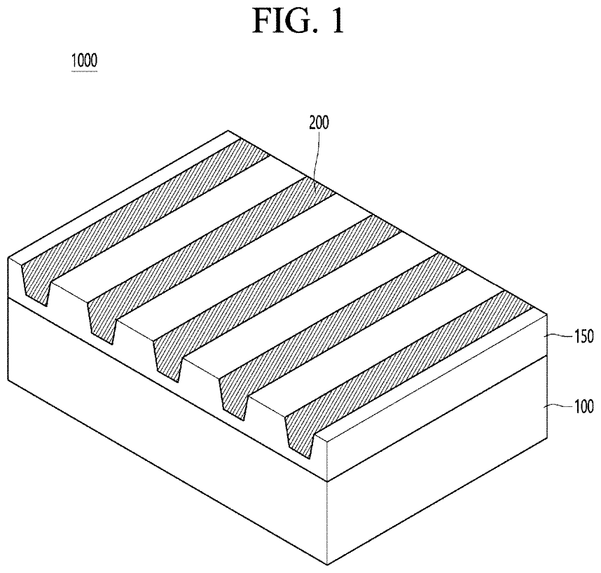

Referring to FIGS. 1 to 6, an optical path control member according to the first embodiment includes a base substrate 100, a resin layer 150, and a pattern portion 200.

The base substrate 100 may contain a transparent material. The base substrate 100 may contain a flexible material. The base substrate 100 may contain plastic.

For example, the base substrate 100 may contain a plastic material such as poly-ester (PET), poly methyl meta acryl (PMMA), or poly carbonate (PA).

One of a lateral direction and a longitudinal direction of the base substrate 100 may be a longer side direction, the other is a shorter side direction, and the base substrate may have a rectangular parallelepiped shape. Alternatively, sides of the base substrate 100 in the lateral direction and the longitudinal direction have the same size, and the base substrate may have a cubic shape.

The base substrate 100 may include one surface and the other surface. For example, the base substrate 100 may include one surface and the other surface opposite to the one surface with respect to a thickness direction of the base substrate 100.

One surface of the base substrate may be defined as a direction viewed by a user. In addition, the other surface of the base substrate may be defined as a direction in which a light source such as a display panel in which light is emitted toward the other surface of the base substrate is disposed. That is, light is emitted from a light source such as a display panel disposed on the other surface of the base substrate, and the emitted light is incident in one surface direction of the base substrate, and a display is displayed so that the user may recognize visually the display on the one surface of the base substrate.

The resin layer 150 may be disposed on the base substrate 100. The resin layer 150 may be disposed in direct contact with the base substrate 150. The resin layer 150 may include a photocurable resin such as a UV resin or a thermosetting resin.

Alternatively, the resin layer 150 may include the same material as the base substrate 100. For example, the resin layer 150 may be integrally formed with the base substrate 100.

The resin layer 150 may be disposed on the other surface of the base substrate 100. That is, the resin layer 140 may be disposed on the other surface of the base substrate 100 facing the display panel.

The resin layer 150 may include a lower surface 1S and an upper surface 2S. In detail, the lower surface 1S of the resin layer may be defined as a surface adjacent to the other surface of the base substrate 100. In addition, the upper surface 2S of the resin layer may be defined as a surface opposite to the lower surface 1S of the resin layer.

Referring to FIG. 3, an intaglio portion may be formed on the upper surface of the resin layer 150. In detail, a plurality of intaglio portions E1 formed penetrating the upper surface 2S may be formed in the resin layer 150. That is, the intaglio portions E1 may have a groove shape in which the upper surface 2S is penetrated and the lower surface 1S is not penetrated.

The intaglio portions E1 may be formed by an imprinting process by disposing a mold or the like on the upper surface 2S of the resin layer 150. The intaglio portions E1 may be formed by penetrating the upper surface 2S of the resin layer and being etched to a predetermined depth, and accordingly, a plurality of intaglio portions having a groove shape in which one end is opened and the other end is closed may be formed in the resin layer.

Accordingly, the intaglio portions E1 and embossed portions E2 between the intaglio portions E1 may be formed on the resin layer 150.

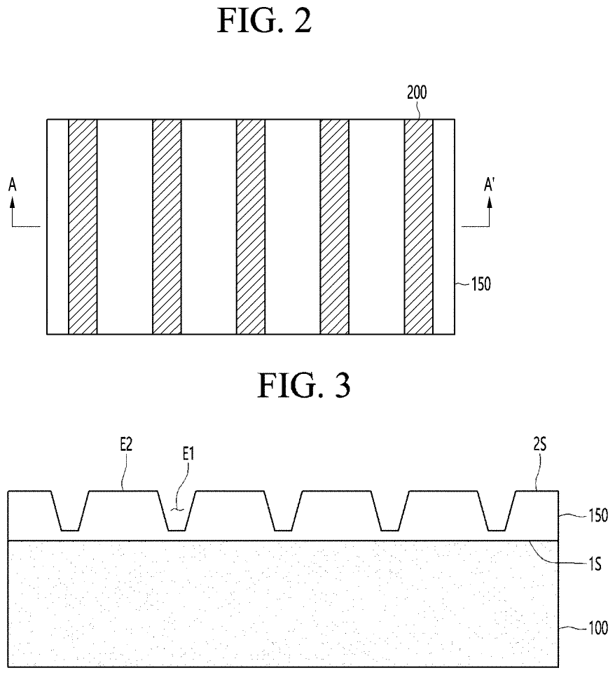

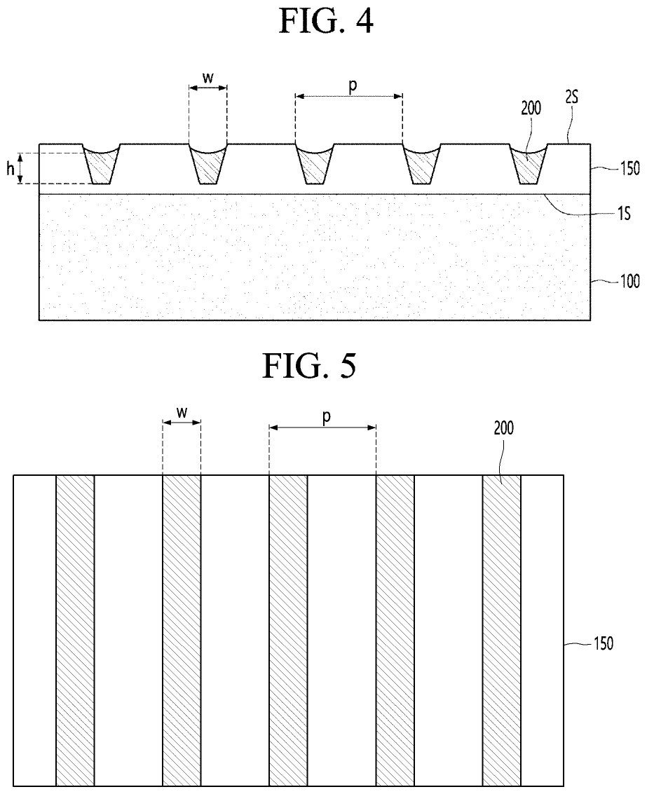

Referring to FIGS. 2 and 4, the pattern portion 200 may be disposed on the base substrate 100. The pattern portion 200 may be disposed on the resin layer 150 on the base substrate 100. In detail, the pattern portion 200 may be disposed in the intaglio portions formed in the resin layer 150.

The pattern portion 200 is disposed in the plurality of intaglio portions, respectively, and accordingly, the pattern portion 200 may include a plurality of pattern portions disposed to be spaced apart from each other.

In FIG. 2, it is illustrated that the pattern portion 200 is disposed in less than 10, but the embodiment is not limited thereto, and the pattern portion 200 may be formed of several to several hundreds depending on the use, size, and the like of the optical path control member.

The pattern portion 200 may include a material having a low light transmittance. The pattern portion 200 may include an opaque material. The pattern portion 200 may include a colored material. For example, the pattern portion 200 may include black carbon ink or black carbon beads. That is, the pattern portion 200 may serve to block light. That is, the pattern portion 200 may be a light blocking pattern.

In addition, the pattern portion 200 and the embossed portion E2 of the resin layer 150 may have different light transmittances. In detail, the light transmittance of the embossed portion E2 of the resin layer 150 may be greater than that of the pattern portion 200.

That is, light incident on the optical path control member may be transmitted in the embossed portion E2 of the resin layer 150, and may be blocked in the pattern portion 200.

In detail, a movement path of incident light may be changed by the pattern portion 200. That is, the optical path control member according to the embodiment may partially block and partially transmit the incident light, such that the light is transmitted only at a desired angle and at a desired position.

A protective layer disposed on the upper surface 2S of the resin layer may be disposed on the resin layer 150. The protective layer may be disposed while covering the pattern portion 200 inside the intaglio portion of the resin layer. Accordingly, the pattern portion may relieve an external impact by the protective layer, and may prevent penetration of impurities such as moisture.

In addition, the protective layer may have an adhesive function. That is, the protective layer may include a release film, and may be adhered to each other by removing the release film when another member and the optical path control member are adhered.

Hereinafter, the pattern portion of the optical path control member according to the first embodiment will be described with reference to the drawings.

Referring to FIGS. 4 and 5, the optical path control member according to the first embodiment may include a plurality of pattern portions having a predetermined pitch.

Referring to FIG. 5, a pitch p of the pattern portion 200 may be about 30 μm or less. In detail, the pitch p of the pattern portion 200 may be about 1 μm to 30 μm. In more detail, the pitch p of the pattern portion 200 may be about 5 μm to 30 μm. In more detail, the pitch p of the pattern portion 200 may be about 9.5 μm to 27.5 μm.

A range of the pitch p of the pattern portion 200 is a range for minimizing moire due to an overlapping phenomenon between patterns when the optical path control member according to the embodiment is coupled to another member.

In detail, in a case of the pattern portion 200, the pattern portion 200 has a directionality extending in one direction or multiple directions, and when the optical path control member including the pattern portion is coupled to a display panel to form a display device, the moire phenomenon may occur due to the overlapping phenomenon between a pattern of the display panel and a pattern of the optical path control member.

The user who looks at the display device from the outside may visually recognize the pattern generated by the moire phenomenon, thereby decreasing visibility of the user.

When the pitch p of the pattern portion exceeds about 30 μm, a pattern due to the moire caused by the pattern portion of the optical path control member and the pattern portion of the other member may be visually recognized from the outside, thereby decreasing the visibility of the user.

At this time, an effect of moire reduction according to the range of the pitch p of the pattern portion may have an optimal effect when the pitch of the pattern of the other member coupled to the optical path control member exceeds about 100 μm.

In detail, the effect of moire reduction according to the range of the pitch p of the pattern portion may have an optimal effect when the pitch of the pattern of the other member coupled to the optical path control member is 100 μm to 150 μm.

In more detail, the effect of moire reduction according to the range of the pitch p of the pattern portion may have an optimal effect when the pitch of the pattern of the other member coupled to the optical path control member is 120 μm to 145 μm.

Meanwhile, the pattern portion 200 may have a predetermined width w. The width w of the pattern portion 200 may be defined as the maximum width of the pattern portion 200 disposed inside the intaglio portion E1.

In detail, the width w of the pattern portion 200 may be 25 μm or less. In more detail, the width w of the pattern portion 200 may be 1μm to 25 μm. In more detail, the width w of the pattern portion 200 may be 3μm to 15 μm.

The width w of the pattern portion 200 may be related to the light transmittance and the light blocking rate of the optical path control member. In detail, since the pattern portion 200 serves to block the movement of light, the light transmittance is decreased as the width of the pattern portion 200 is increased, but conversely, the light blocking rate is increased, and the light transmittance is increased as the width of the pattern portion 200 is decreased, but conversely, the light blocking rate may be reduced.

The width of the pattern portion 200 may be variously changed depending on the emission angle of the light to be implemented within the above range.

Meanwhile, the pattern portion 200 may have a predetermined height h. The height h of the pattern portion 200 may be defined as the maximum height of the pattern portion 200 disposed inside the intaglio portion E1. In detail, the height h of the pattern portion 200 may be defined as a distance from a contact surface of the pattern portion 200 and a lower surface of the intaglio portion E1 to the maximum height of an upper surface of the pattern portion 200.

In addition, the height h of the pattern portion 200 may be about 120 μm or less. In detail, the height h of the pattern portion 200 may be about 20 μm to about 120 μm. In more detail, the height h of the pattern portion 200 may be about 50 μm to about 100 μm.

It is difficult to realize in a process that the height h of the pattern portion 200 exceeds about 120 μm, and a thickness of the optical path control member may be increased by the height of the pattern portion 200, and thus it is difficult to reduce the thickness.

In addition, as the height of the pattern portion 200 is increased, the force supporting the pattern is decreased, so that the pattern portion may be easily damaged by an external impact, thereby deteriorating reliability of the optical path control member.

In addition, when the height of the pattern portion 200 is increased, the width of the pattern portion should also be increased to improve the force supporting the pattern portion, but in this case, a region in which the light is blocked becomes too wide, so that the front transmittance of the optical path control member may be reduced, thereby deteriorating the user's visibility.

In addition, the height h of the pattern portion 200 may be equal to or less than an inner depth of the intaglio portion formed in the resin layer 150. Thus, when the optical path control member including the pattern portion 200 and the display are coupled to each other, it is possible to prevent an adhesion failure due to a pattern exposed to the outside, thereby improving reliability.

In detail, an upper surface of the pattern portion 200 may include a concave shape, and a region in which the pattern portion is not filled may be formed inside the intaglio portion of the resin layer 150 by the concave shape. Thus, the upper surface of the pattern portion 200 may include a maximum upper surface and a minimum upper surface.

Preferably, the pattern portion 200 may be disposed at a height of 90% or more and less than 100% of the maximum depth of the intaglio portion formed in the resin layer 150. In detail, the pattern portion 200 may be disposed at a height of 91% or more and less than 98% of the maximum depth of the intaglio portion formed in the resin layer 150. In detail, the pattern portion 200 may be disposed at a height of 93% or more and less than 96% of the maximum depth of the intaglio portion formed in the resin layer 150.

When the pattern portion is formed at 90% or less of the maximum depth of the intaglio portion formed in the resin layer, the resin layer is thickened with respect to the height of the pattern portion for forming the same shielding function, so that the overall thickness of the optical path control member is thickened, and when it is 100% or more, an adhesion failure between the optical path control member and the display or a protective film may occur.

In addition, when the height h of the pattern portion is less than about 20 μm, the light blocking effect by the pattern portions may be reduced. In addition, since the height of the pattern portion is too low, it may be visible to other users outside a required viewing angle range, which may cause privacy problems, and a virtual image is displayed on a front glass or a window of a vehicle, which may obstruct the user's field of view, and brightness of the light may be reduced at the viewing angle seen by the user due to dispersion of the light.

Hereinafter, the present invention will be described in more detail through measuring the moire of the optical path control member according to the first embodiment and comparative examples. These examples are merely illustrative to describe the present invention in more detail. Therefore, the present invention is not limited thereto.

### EXAMPLE

After a UV resin was disposed on a polyethylene terephthalate substrate, a plurality of intaglio portions and a plurality of embossed portions disposed between the plurality of intaglio portions were formed on the UV resin by an imprinting process.

Subsequently, black ink was filled by screen printing in a plurality of intaglio portions to form a pattern portion in the intaglio portions.

Subsequently, black ink adhering to regions other than the intaglio portions was removed to manufacture a final optical path control member.

Subsequently, the optical path control member was disposed on the display panel, and then the optical path control member and the display panel were adhered by an adhesive layer.

Subsequently, the moire phenomenon of light emitted from the display panel, incident from an upper surface of the UV resin, and emitted in a direction of the polyethylene terephthalate substrate was observed.

At this time, the moire phenomenon was observed in a range in which the pitch of the pattern portion is 30 μm or less (Example 1 to Example 16).

At this time, the presence or absence of the moire was determined that the moire is generated when a coupling wavelength λ is 2,500 or more, and the moire is not generated when the coupling wavelength λ is less than 2500 by measuring the coupling wavelength λ (μm) using the following equation.

In detail, the coupling wavelength λ may be defined by the following equation using the pitch and a number of pattern portions of the optical path control member and a pitch and a number of pixel patterns of the display panel.

$$λ = {\vert \frac{k}{{p}_{1}} - \frac{m}{{p}_{2}} \vert}^{- 1} \qquad [ Equation ]$$

(P1 is a pitch of the pattern portion of the optical path control member, P2 is a pitch of the pixel pattern of the display panel, k is a number of pattern portions of the optical path control member, and m is a number of pixel patterns of the display panel.)

At this time, the pitch of the pixel pattern of the display panel is selected in a range from 123 μm to 141 μm.

In addition, as shown in Table 1 below, the moire phenomenon was observed in the ranges (series 1 to series 16) of the number k of the pattern portion of the optical path control member and the number m of the pixel patterns of the display panel.

TABLE 1

| | Number of pattern | Number of pixel |
|---|---|---|
| | portions of optical | patterns of |
| | path control members (k) | display panel (m) |
| Series 1 | 1 | 4 |
| Series 2 | 1 | 3 |
| Series 3 | 1 | 3 |
| Series 4 | 1 | 3 |
| Series 5 | 1 | 4 |
| Series 6 | 1 | 4 |
| Series 7 | 3 | 4 |
| Series 8 | 1 | 3 |
| Series 9 | 2 | 4 |
| Series 10 | 1 | 4 |
| Series 11 | 2 | 3 |
| Series 12 | 2 | 4 |
| Series 13 | 3 | 4 |
| Series 14 | 2 | 3 |
| Series 15 | 1 | 3 |
| Series 16 | 2 | 4 |

### Comparative Example

After the optical path control member was manufactured in the same manner as in Example, except that the pitch of the pattern portion exceeded 30 μm, in the range in which the pitch of the pattern portion exceeded 30 μm (Comparative Examples 1 to 16), the moire phenomenon in the pitch ranges (Series 1 to 16) of the display panel was observed in the same manner as in Example.

TABLE 2

| | Number of | | | | | |
|---|---|---|---|---|---|---|
| | pattern | | | | | |
| | portions of | | | | | |
| | optical | | Number of | | | |
| | path | Pitch of | pixel | Pattern | | |
| | control | pattern | patterns of | pitch of | Coupling | |
| | members | portion | display panel | display | Wavelength | Moire |
| | (k) | (μm) | (m) | panel (μm) | (λ) | occurrence |
| Example 1 | 1 | 15 | 4 | 141 | 26 | No |
| Example 2 | 1 | 16 | 3 | 141 | 24 | No |
| Example 3 | 1 | 17 | 3 | 138 | 27 | No |
| Example 4 | 1 | 18 | 3 | 138 | 30 | No |
| Example 5 | 1 | 19 | 4 | 135 | 43 | No |
| Example 6 | 1 | 20 | 4 | 135 | 49 | No |
| Example 7 | 3 | 21 | 4 | 135 | 9 | No |
| Example 8 | 1 | 22 | 3 | 132 | 44 | No |
| Example 9 | 2 | 23 | 4 | 132 | 18 | No |
| Example 10 | 1 | 24 | 4 | 129 | 94 | No |
| Example 11 | 2 | 25 | 3 | 129 | 18 | No |
| Example 12 | 2 | 26 | 4 | 129 | 22 | No |
| Example 13 | 3 | 27 | 4 | 126 | 13 | No |
| Example 14 | 2 | 28 | 3 | 126 | 21 | No |
| Example 15 | 1 | 29 | 3 | 123 | 99 | No |
| Example 16 | 2 | 30 | 4 | 123 | 29 | No |
| Comparative | 1 | 35 | 4 | 141 | 4.935 | Yes |
| Example 1 | | | | | | |
| Comparative | 1 | 46.5 | 3 | 141 | 4.371 | Yes |
| Example 2 | | | | | | |
| Comparative | 1 | 45 | 3 | 138 | 2.070 | Yes |
| Example 3 | | | | | | |
| Comparative | 1 | 45.5 | 3 | 138 | 4.186 | Yes |
| Example 4 | | | | | | |
| Comparative | 1 | 33.5 | 4 | 135 | 4.523 | Yes |
| Example 5 | | | | | | |
| Comparative | 1 | 34 | 4 | 135 | 4.590 | Yes |
| Example 6 | | | | | | |
| Comparative | 3 | 102 | 4 | 135 | 4.590 | Yes |
| Example 7 | | | | | | |
| Comparative | 1 | 44.5 | 3 | 132 | 3.916 | Yes |
| Example 8 | | | | | | |
| Comparative | 2 | 65.5 | 4 | 132 | 4.323 | Yes |
| Example 9 | | | | | | |
| Comparative | 1 | 32 | 4 | 129 | 4.128 | Yes |
| Example 10 | | | | | | |
| Comparative | 2 | 85 | 3 | 129 | 3.655 | Yes |
| Example 11 | | | | | | |
| Comparative | 2 | 65 | 4 | 129 | 4.193 | Yes |
| Example 12 | | | | | | |
| Comparative | 3 | 94 | 4 | 126 | 5.922 | Yes |
| Example 13 | | | | | | |
| Comparative | 2 | 85 | 3 | 126 | 3.570 | Yes |
| Example 14 | | | | | | |
| Comparative | 1 | 41.5 | 3 | 123 | 3.403 | Yes |
| Example 15 | | | | | | |
| Comparative | 2 | 60.5 | 4 | 123 | 1.860 | Yes |
| Example 16 | | | | | | |

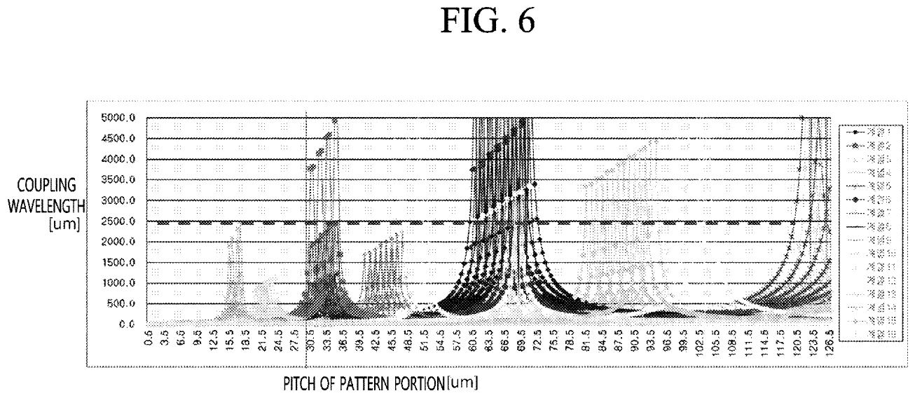

Referring to Table 2 and FIG. 6, it can be seen that the optical path control member according to the embodiment does not generate the moire phenomenon, while the optical path control member according to Comparative Example generates the moire phenomenon in a partial region.

FIG. 6 is a graph for the coupling wavelength measured while increasing the pitch P1 of the pattern portion of the optical path control member by 0.5 μm from 0.5 μm to 126.5 μm for each of 123, 126, 129, 132, 135, 138, and 141 μm of the pitches P2 of the display panels of the series 1 to series 16.

As shown in FIG. 6, when the pitch P1 of the pattern portion of the optical path control member is 30 μm or less, all of the series and the display panel have a coupling wavelength of less than 2,500 μm regard1ess of the pitch P2 of the series and the display panel, and thus it can be seen that the moire phenomenon does not occur. That is, when the pitch P1 of the pattern portion of the optical path control member is designed to be 30 μm or less, the moire phenomenon may be controlled without considering the pitch of the display panel, the number of patterns of the optical path control member, and the number of pixels of the display panel.

In detail, when the pitch of the pattern portion of the optical path control member is 30 μm or less, the moire phenomenon does not occur. On the other hand, when the pitch of the pattern portion of the optical path control member exceeds 30 μm, it can be seen that the moire phenomenon occurs in some regions as shown in Table 1.

Examples 1 to 16 of Table 2 are a case in which the pitch of the pattern portion is 30 μm or less, and represent some examples of the various examples of FIG. 6 as a table. However, as shown in FIG. 6, since the coupling wavelength is less than 2,500 μm in all Examples in which the pitch of the pattern portion is 30 μm or less, the moire phenomenon does not occur, and Comparative Examples 1 to 16 represent some examples in which the moire phenomenon occurs in the various Comparative Examples of FIG. 6 as a table.

In conclusion, the optical path control member according to Examples may control the pitch of the pattern portion to a specific range, thereby optimally reducing the moire due to the overlapping of the patterns of the optical path control member and the display panel.

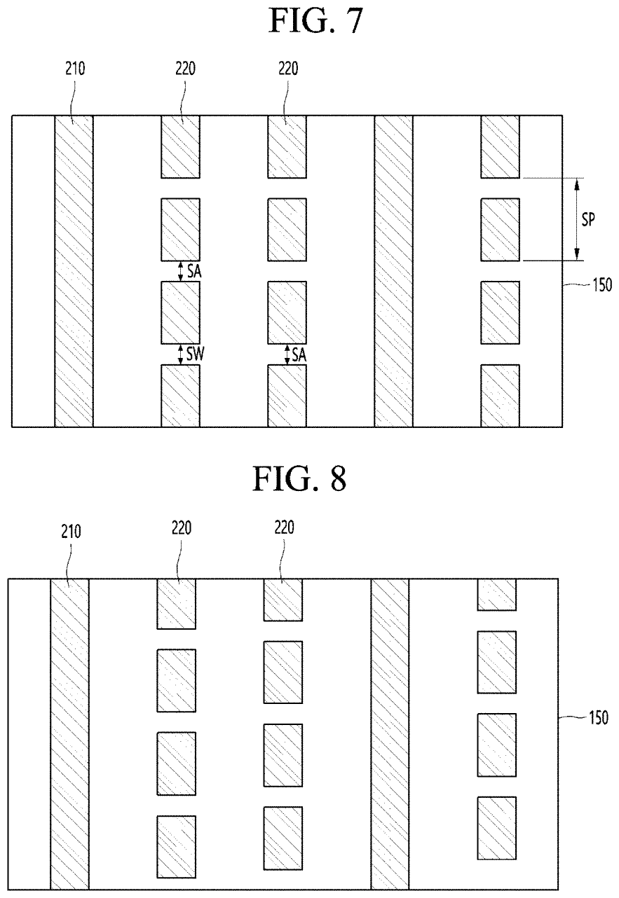

Hereinafter, an optical path control member according to another first embodiment will be described with reference to FIGS. 7 to 12. In the description of the optical path control member according to the other the first embodiment, the description that is the same as or similar to that of the optical path control member according to the first embodiment described above will be omitted. In addition, the same configurations are designated by the same reference numerals.

The optical path control member according to the other first embodiment may include pattern portions having a shape different from that of the pattern portion of the optical path control member according to the first embodiment described above.

In detail, referring to FIGS. 7 to 12, a pattern portion 200 of the optical path control member according to the other first embodiment may include a first pattern portion 210 and a second pattern portion 220.

The first pattern portion 210 and the second pattern portion 220 may be formed in different shapes.

In detail, the first pattern portion 210 may be formed in a stripe shape. That is, the first pattern portion 210 may be formed extending from one end to the other end of the resin layer 150 in one direction. That is, the first pattern portion 210 may be connected from one end to the other end of the resin layer 150 in one direction without a short-circuited portion.

Similar to the first pattern portion 210, the second pattern portion 220 may be formed extending from one end to the other end of the resin layer 150 in one direction. However, unlike the first pattern portion 210, a short-circuited portion SA may be formed in the second pattern portion 220. That is, the second pattern portion 220 may have the short-circuited portion SA formed in a plurality of regions of the pattern portion, and thus may not be connected from one end to the other end of the resin layer 150 in one direction.

A plurality of short-circuited portions SA may be formed in the second pattern portion 220. In addition, widths of the short-circuited portions SA may be the same or different from each other.

A width sw of the short-circuited portions SA may be 50 μm or less. In detail, the width of the short-circuited portions SA may be 1 μm to 50 μm. In more detail, the width of the short-circuited portions SA may be 15 μm to 35 μm.

When the width sw of the short-circuited portions SA exceeds about 50 μm, a region through which light is transmitted may increase to increase brightness, but haze may increase to cause spots.

Referring to FIGS. 7 to 9, the second pattern portion 220 may include a plurality of short-circuited portions, and the width sw of the short-circuited portions SA may all be the same or similar to each other. In addition, a pitch sp of the short-circuited portions SA may all be the same or similar.

That is, the short-circuited portions of the second pattern portion 220 may be formed in a regular shape.

In addition, referring to FIG. 7, short-circuited portions of each of the pattern portions of the second pattern portions 220 may be formed to be overlapped with each other.

Alternatively, referring to FIG. 8, short-circuited portions of each of the pattern portions of the second pattern portions 220 may be formed to be partially overlapped with each other.

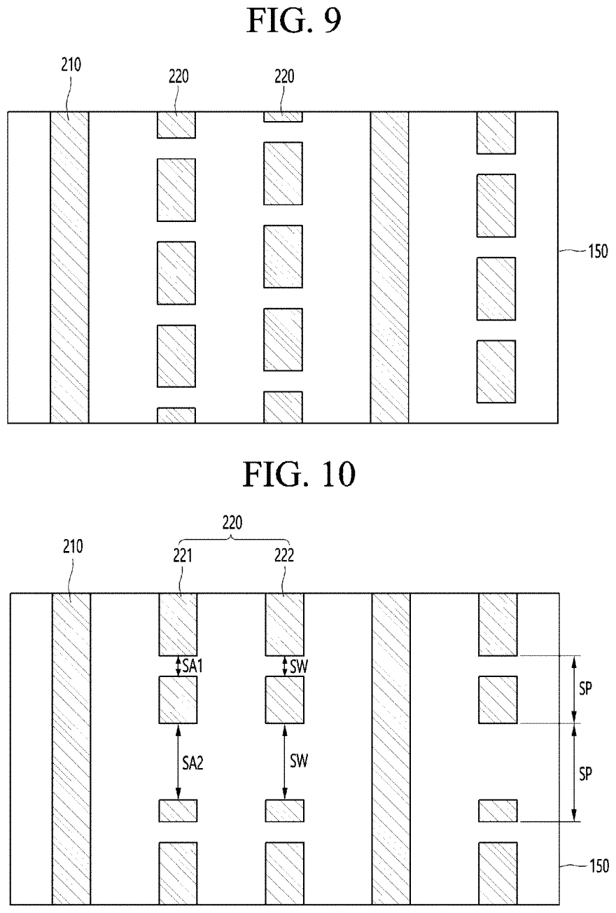

Alternatively, referring to FIG. 9, short-circuited portions of each of the pattern portions of the second pattern portions 220 may be formed not to be overlapped with each other.

Meanwhile, a ratio of the first pattern portion 210 and the second pattern portion 220 may be different. In detail, the ratio of the second pattern portion 220 may be greater than the ratio of the first pattern portion 210.

That is, the ratio of the second pattern portion 220 among the entire pattern portions included in one optical path control member may be greater than the ratio of the first pattern portion 210. In detail, the ratio of the second pattern portion 220 and the ratio of the first pattern portion 210 may be greater than about 1:1 to 3:1.

Unlike this, the widths of the plurality of short-circuited portions SA of the second pattern portion 220 may be different from each other.

Referring to FIGS. 10 to 12, the second pattern portion 220 may include the plurality of short-circuited portions, and the width sw of the short-circuited portions SA may be different from each other. Also, the pitches sp of the short-circuited portions SA may be different from each other.

In detail, the second pattern portion may include a second-first pattern portion 221 having a shape different from that of the first pattern portion 210 and a second-second pattern portion 222 having a shape different from those of the first pattern portion 210 and the second-first pattern portion 221.

The first pattern portion 210, the second-first pattern portion 221, and the second-second pattern portion 222 may have the same extension direction, but may have different shapes.

In detail, the first pattern portion 210 may extend when the first pattern portion 210 is connected in one direction without the short-circuited portion. In addition, the second-first pattern portion 221 and the second-second pattern portion 222 may have a short-circuited portion, and a first short-circuited portion SA1 of the second-first pattern portion 221 and a second short-circuited portion SA2 of the second-second pattern portion 222 may be extended in one direction with different widths and pitches.

That is, each second pattern portion of the second pattern portions may be formed in an irregular shape having a different width and pitch.

In detail, the first short-circuited portion SA1 and the second short-circuited portion SA2 may have different widths at a width of about 50 μm or less.

In addition, referring to FIG. 10, the short-circuited portions of each pattern portion of the second-first pattern portions 210 and the second-second pattern portions 220 may be formed to be overlapped with each other.

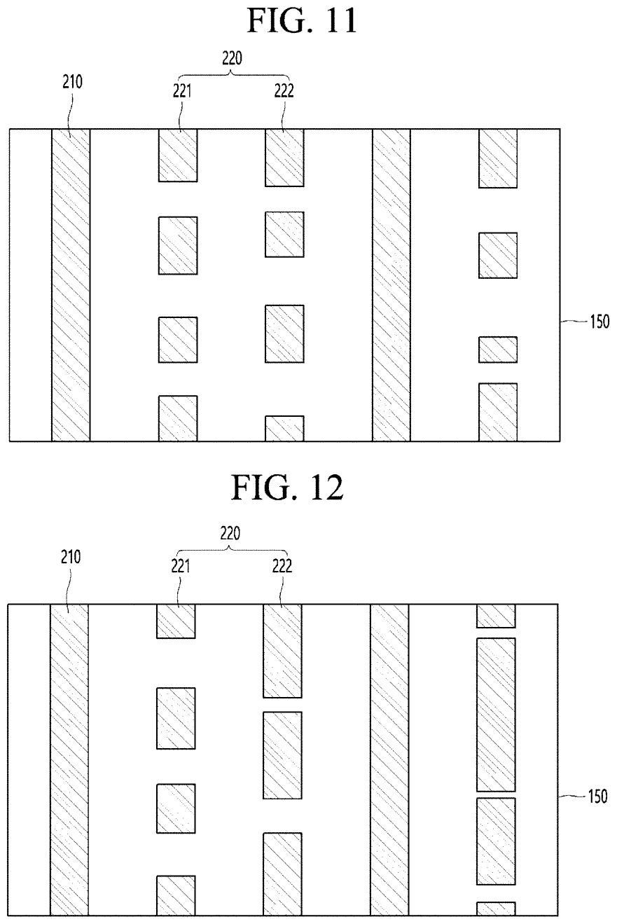

Alternatively, referring to FIG. 11, the short-circuited portions of each pattern portion of the second-first pattern portions 210 and the second-second pattern portions 220 may be formed to be partially overlapped with each other.

Alternatively, referring to FIG. 12, the short-circuited portions of the pattern portions of the second-first pattern portions 210 and the second-second pattern portions 220 may not be overlapped with each other.

Accordingly, the optical path control member according to another embodiment may increase brightness as well as a moire reduction effect. That is, the light transmittance and the brightness in a front direction may be increased by increasing a region through which light is transmitted by a short-circuited portion of the second pattern portion.

Accordingly, when a user looks at the display device including the optical path control member from the outside, a greater amount of light may be transmitted, thereby improving visibility.

In addition, when the optical path control member is coupled to another member, a moire phenomenon due to an overlapping phenomenon of patterns may be more effectively reduced by increasing irregularity of the pattern by arranging the short-circuited portion unevenly and forming a width and pitch of the short-circuited portion unevenly.

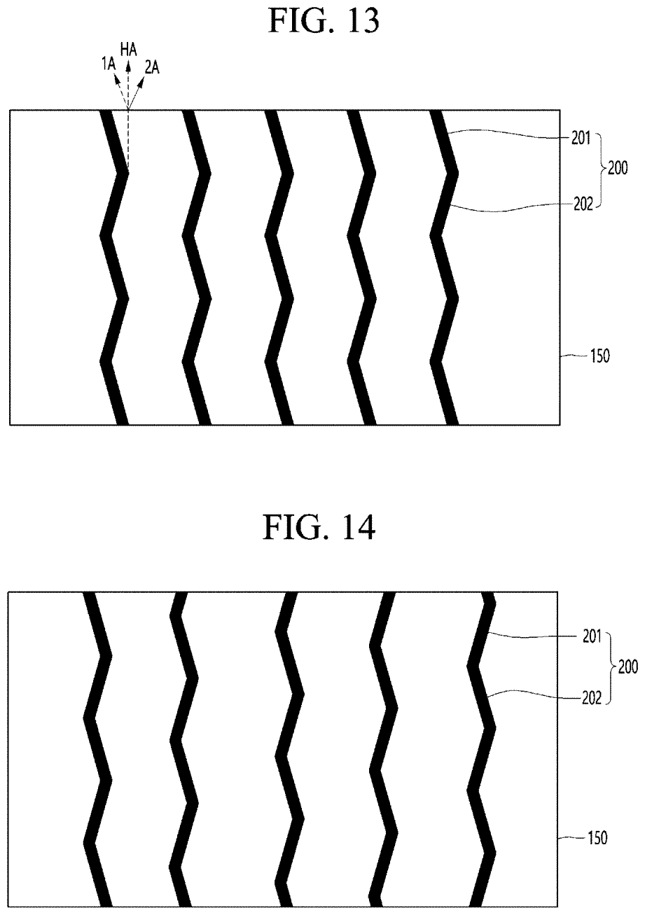

Hereinafter, an optical path control member according to still another first embodiment will be described with reference to FIGS. 13 to 15. In the description of the optical path control member according to still another first embodiment, the description that is the same as or similar to that of the optical path control member according to the first embodiments described above will be omitted. In addition, the same configurations are designated by the same reference numerals.

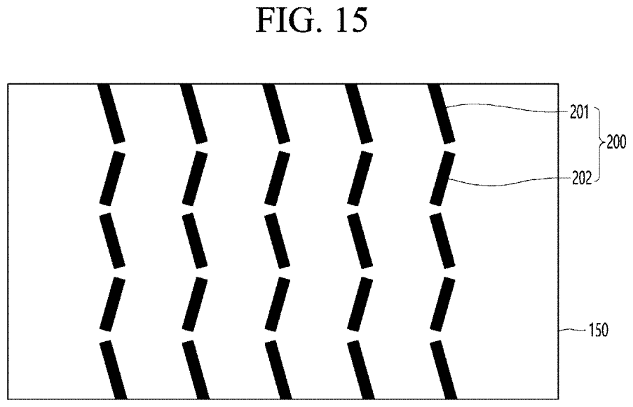

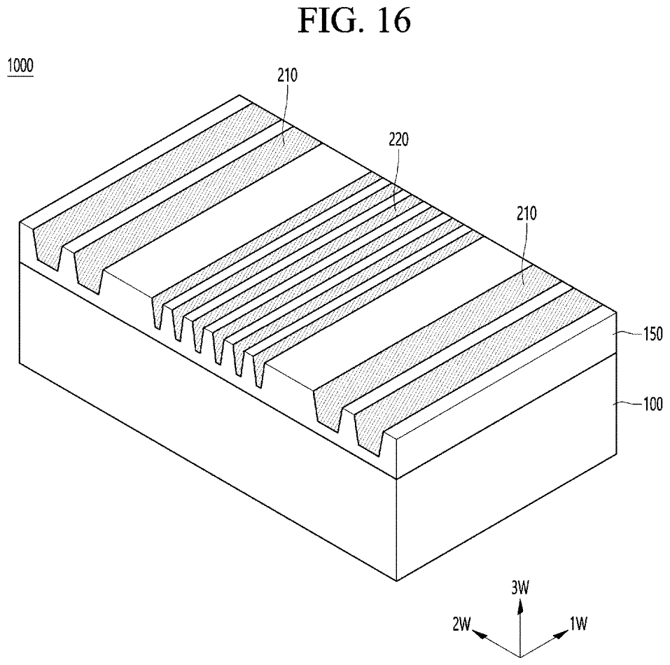

Referring to FIGS. 13 and 14, the optical path control member according to still another embodiments may include a pattern portion of the optical path control member according to the first embodiments described above and pattern portions having different extension directions.

In detail, the pattern portions of the optical path control member extend from one end toward the other end, and at this time, directionality of the pattern portions may be changed while extending in the extension direction.

In detail, the pattern portions 200 may extend from one end toward the other end of the resin layer 150. That is, the pattern portions may extend in one direction on the resin layer 150.

In addition, the pattern portions may extend in the one direction, and may be formed extending in first and second directions. In detail, the first direction and the second direction may be defined as different directions, and the pattern portions may be formed so as to have at least two directions while extending in the one direction.

That is, each pattern portion may include a first sub pattern portion 201 extending in the first direction and a second sub pattern portion 202 extending in the second direction different from the first direction.

In detail, when the one direction is defined as a horizontal direction PA, the first direction 1A may be a direction angled at about 10° or less in an upward direction with respect to the horizontal direction, and the second direction 2A may be a direction angled at about 10° or less in a downward direction with respect to the horizontal direction.

That is, each pattern portion of the pattern portions may extend while having several inflection points having the first direction and the second direction.

Although FIG. 13 illustrates that the inflection points of the plurality of pattern portions are all formed at the same position, the embodiment is not limited thereto, and as shown in FIG. 14, each of the inflection points may be formed at a position different from each other to further increase the irregularity of the pattern.

Meanwhile, referring to FIG. 15, the pattern portions may extend while having the first direction and the second direction, and at least one pattern portion of the plurality of pattern portions may extend while having a short-circuited portion SA.

Accordingly, as described above, brightness of the optical path control member may be increased by increasing an area of a light transmitting region while increasing the irregularity of the pattern.

In addition, in the optical path control member according to still another first embodiment, the irregularity of the pattern may be increased by forming the pattern portion to have a plurality of directions. Accordingly, when the optical path control member is coupled to another member, the moire phenomenon due to the overlapping phenomenon of the patterns may be more effectively reduced.

In addition, the moire reduction effect and the brightness may be increased by forming an additional short-circuited portion in the pattern portion. That is, the light transmittance and the brightness in a front direction may be increased by increasing a region through which light is transmitted by a short-circuited portion of the pattern portion.

Accordingly, when the user looks at the display device including the optical path control member from the outside, a greater amount of light may be transmitted, thereby improving visibility.

Hereinafter, an optical path control member according to a second embodiment will be described with reference to FIGS. 16 to 24. In description of the optical path control member according to the second embodiment, the description that is the same as or similar to that of the optical path control member according to the first embodiment described above will be omitted. In addition, in the description of the optical path control member according to the second ggembodiment, the same components as the optical path control member according to the first embodiment described above are designated by the same reference numerals.

Referring to FIGS. 16 to 20, the optical path control member according to the second embodiment may include a base substrate 100, a resin layer 150, and a pattern portion 200.

Since description of materials, shapes, positions, and the like of the base substrate 100 and the resin layer 150 is the same as that of the base substrate 100 and the resin layer 150 of the optical path control member according to the first embodiment described above, the following description will be omitted. Hereinafter, the description will be given focusing on a pattern portion having properties different from the optical path control member according to the first embodiment.

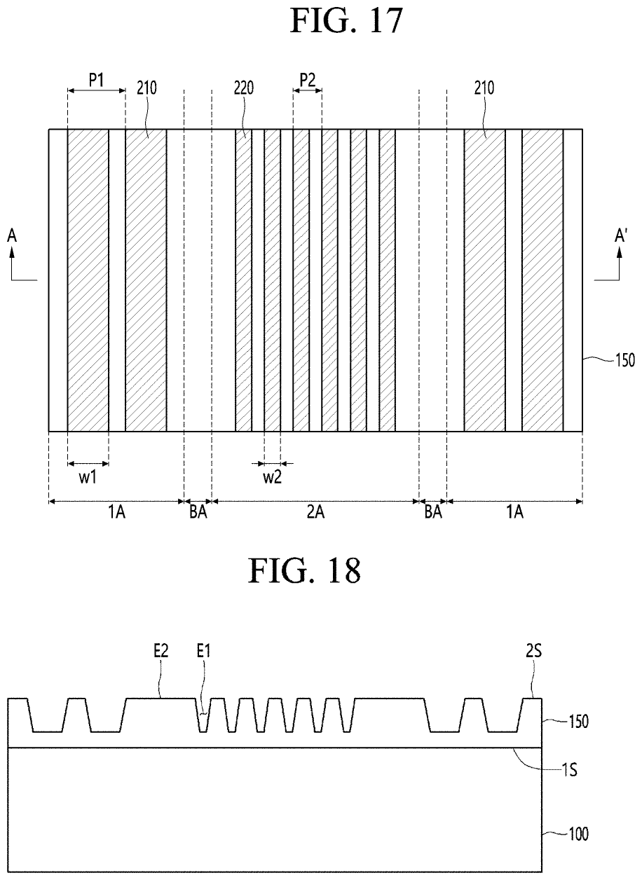

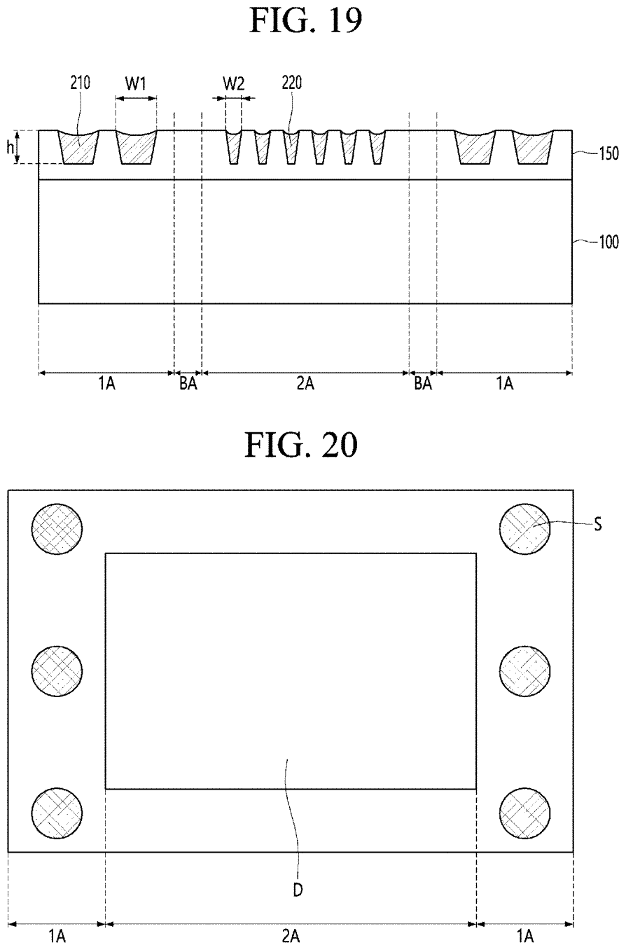

Referring to FIGS. 17 and 19, the pattern portions 230 and 240 may be disposed on the base substrate 100. The pattern portions 230 and 240 may be disposed on the resin layer 150 on the base substrate 100. In detail, the pattern portions 230 and 240 may be disposed in the intaglio portions formed in the resin layer 150.

The pattern portions 230 and 240 are disposed in the plurality of intaglio portions, respectively, and accordingly, the pattern portions 230 and 240 may include a plurality of pattern portions disposed to be spaced apart from each other.

The pattern portions 230 and 240 may contain a material having a low light transmittance. The pattern portions 230 and 240 may contain an opaque material. The pattern portions 230 and 240 may contain a colored material. For example, the pattern portions 230 and 240 may contain black carbon ink or black carbon beads. That is, the pattern portions 230 and 240 may serve to block light. That is, the pattern portions 230 and 240 may be light blocking patterns.

In addition, the pattern portions 230 and 240 and the embossed portion E2 of the resin layer 150 may have different light transmittances. In detail, the light transmittance of the embossed portion E2 of the resin layer 150 may be greater than those of the pattern portions 230 and 240.

That is, light incident on the optical path control member may be transmitted in the embossed portion E2 of the resin layer 150, and may be blocked by the pattern portions 230 and 240.

In detail, a movement path of incident light may be changed by the pattern portions 230 and 240. That is, the optical path control member according to the embodiment may partially block and partially transmit the incident light, such that the light is transmitted only at a desired angle and at a desired position.

For example, a path of light in a vertical direction or a horizontal direction based on a user may be controlled by the pattern portions 230 and 240. That is, light that deviates more than a specific angle in the vertical direction or the horizontal direction based on a user's viewing angle according to a direction in which the pattern portion extends may not be transmitted.

For example, when the optical path control member according to the embodiment is applied to a vehicle, it is possible to prevent a virtual image or the like that is recognized by light reflected from left and right windows of the vehicle or a windshield of the vehicle while driving. Accordingly, it is possible to prevent a virtual image that obstructs a field of view while driving the vehicle, thereby preventing a risk of an accident associated therewith.

A protective layer disposed on the upper surface 2S of the resin layer may be disposed on the resin layer 150. The protective layer may be disposed while covering the pattern portions 230 and 240 inside the intaglio portion of the resin layer. Accordingly, the pattern portion may relieve an external impact by the protective layer, and may prevent penetration of impurities such as moisture.

In addition, the protective layer may have an adhesive function. That is, the protective layer may include a release film, and may be adhered to each other by removing the release film when another member and the optical path control member are adhered.

In addition, a height h of the pattern portions 230 and 240 may be about 120 μm or less. In detail, the height h of the pattern portions 230 and 240 may be about 20 μm to about 120 μm. In more detail, the height h of the pattern portions 230 and 240 may be about 50 μm to about 100 μm.

The height h of the pattern portions 230 and 240 may be defined as a distance from the upper region to the lower region of the pattern portion. In detail, the height h of the pattern portions 230 and 240 may be defined as a distance from the lowest point of the upper region to the lowest point of the lower region.

It is difficult to realize in a process that the height h of the pattern portions 230 and 240 exceeds about 120 μm, and a thickness of the optical path control member may be increased by the height of the pattern portions 230 and 240, and thus it is difficult to reduce the thickness. In addition, as the height of the pattern portions 230 and 240 is increased, the force for supporting the pattern is decreased, so that the pattern portion may be easily damaged by an external impact, thereby deteriorating reliability. In addition, when the height of the pattern portions 230 and 240 is increased, the width of the pattern portion should be increased to improve the force supporting the pattern portion, but in this case, a region in which the light is blocked becomes too wide, so that the front transmittance may be reduced, thereby deteriorating the user's visibility.

In addition, the height h of the pattern portions 230 and 240 may be equal to or less than an inner depth of the intaglio portion formed in the resin layer 150. Thus, when the optical path control member including the pattern portions 230 and 240 and the display are coupled to each other, it is possible to prevent an adhesion failure due to a pattern exposed to the outside, thereby improving reliability. In detail, the upper surfaces of the pattern portions 230 and 240 may include a concave shape, and a region in which the pattern portion is not filled may be formed inside the intaglio portion of the resin layer 150 by the concave shape.

Preferably, the pattern portions 230 and 240 may be disposed at a height of 90% or more and less than 100% of the maximum depth of the intaglio portion formed in the resin layer 150. In detail, the pattern portions 230 and 240 may be disposed at a height of 91% or more and less than 98% of the maximum depth of the intaglio portion formed in the resin layer 150. In detail, the pattern portions 230 and 240 may be disposed at a height of 93% or more and less than 96% of the maximum depth of the intaglio portion formed in the resin layer 150.

When the pattern portion is formed at 90% or less of the maximum depth of the intaglio portion formed in the resin layer, the resin layer is thickened with respect to the height of the pattern portion for forming the same shielding function, so that the overall thickness of the optical path control member is thickened, and when it is 100% or more, an adhesion failure between the optical path control member and the display or a protective film may occur.

In addition, when the height h of the pattern portion is less than about 20 μm, the light blocking effect by the pattern portions may be reduced. In addition, since the height of the pattern portion is too low, it may be visible to other users outside a required viewing angle range, which may cause privacy problems, and a virtual image is displayed on a front glass or a window of a vehicle, which may obstruct the user's field of view, and brightness of light may be reduced and the moire phenomenon may occur at the viewing angle seen by the user due to dispersion of the light.

A distance between the intaglio portions E1 may be changed while extending from one end to the other end of the resin layer 150. In detail, the distance between the intaglio portions E1 may be increased or decreased while extending from one end to the other end of the resin layer 150.

That is, the distance between the pattern portions 230 and 240 disposed inside the intaglio portion E1 may also be increased or decreased while extending from one end to the other end of the resin layer 150.

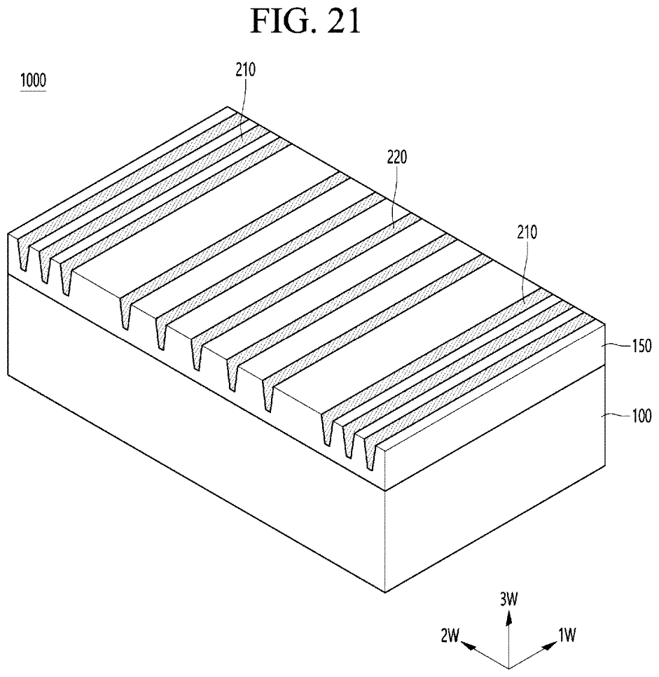

For example, the base substrate 100 may include a first region 1A and a second region 2A. For example, the first region lA may be defined as an outer region of the base substrate 100, and the second region 2A may be defined as a central region of the base substrate 100. For example, as shown in FIG. 20, when the optical path control member according to the embodiment is applied to a vehicle, the first region 1A may be defined as a signal portion S that displays a warning signal or the like. The second region 2A may be defined as a display portion D that displays a speed, an engine, a navigation system, and the like.

In this case, sizes of the first region 1A and the second region 2A may be the same. Alternatively, the size of the first region 1A and the second region 2A may be different. For example, when the optical path control member according to the embodiment is applied to a vehicle, the size of the second region 2A defined as the display portion may be larger than the size of the first region 1A defined as the signal portion.

Alternatively, the size of the second region defined as the display portion may be smaller than the size of the first region defined as the signal portion. This may be different depending on a manufacturing method.

For example, in case of a real vehicle, areas between the display portion and the signal portion exist, and when the inter-areas BA are formed in the same pattern as the signal portion, the size of the first region of the optical path control member may be larger than the size of the second region, and when the inter-area BA is formed in the same pattern as the display portion, the size of the second region of the optical path control member may be larger than the size of the first region.

Meanwhile, a width of the inter-area BA may be larger than the distance between the pattern portions of the display portion or the distance between the pattern portions of the signal portion.

In addition, types of light sources of light emitted toward the first region 1A and the second region 2A may be different from each other. For example, light may be emitted by a light source such as an LED in the first region 1A, and light may be emitted by a display panel, that is, a light source such as an LCD or an OLED in the first region 1A.

Accordingly, relative light transmittances of the first region 1A and the second region 2A may be different from each other. In detail, in the second region 2A, the light transmittance of the light emitted from the light source may be smaller than that of the first region 1A by the display panel disposed on the light source in addition to the light source.

In addition, the resin layer 150 disposed on the base substrate 100 may also include a region corresponding to the first region and a region corresponding to the second region.

The pattern portion may include a third pattern portion 230 disposed on the first region 1A and a fourth pattern portion 240 disposed on the second region 2A.

The third pattern portion 230 and the fourth pattern portion 240 may be formed with different widths. For example, a first width w1 of the third pattern portion 230 may be larger than a second width w2 of the fourth pattern portion 240.

In detail, the first width w1 of the third pattern portion 230 may be about 25 μm or less. In detail, the first width w1 of the third pattern portion 230 may be 15 μm to 25 μm. In addition, the second width w2 of the fourth pattern portion 240 may be about 10 μm or more. In detail, the second width w2 of the fourth pattern portion 240 may be 10 μm to 20 μm. The second width w2 may be formed smaller than the first width w1 within the range.

When a size of the first width w1 and/or the second width w2 exceeds about 25 μm, the overall size of the optical path control member may be increased by the third pattern portion 230 and the fourth pattern portion 240, and the width of the pattern portion serving to block light is increased, so that the overall brightness of the optical path control member may be lowered as the region through which light is transmitted is reduced.

In addition, when the size of the first width w1 and/or the second width w2 is less than about 10 μm, an area supporting the pattern portion may be reduced, whereby a light blocking effect due to the patterns may be reduced. The pattern portion may be easily damaged by an external impact, thereby deteriorating reliability.

Meanwhile, a difference in size between the first width w1 and the second width w2 may be about 1 μm to 15 μm. In detail, the difference in size between the first width w1 and the second width w2 may be about 5 μm to 15 μm.

When the difference in size between the first width w1 and the second width w2 is less than about 1 μm, a difference in amount of light transmitted through the first region 1A and the second region 2A becomes small, whereby it is difficult to control the amount of light transmitted for each region, and thus, the overall brightness uniformity may be deteriorated. Further, when the difference in size between the first width w1 and the second width w2 exceeds about 15 μm, the difference in the amount of light transmitted through the first region 1A and the second region 2A is rapid1y increased, whereby the brightness uniformity may be deteriorated due to a brightness difference in each region.

In addition, a first pitch pl of the third pattern portion 230 may be about 60 μm or less. In detail, the first pitch pl of the third pattern portion may be 50 μm to 60 μm.

In this case, the first pitch of the third pattern portion 230 may be defined as a distance from one end of a third pattern portion to one end of another third pattern portion, which are adjacent to each other.

In addition, a second pitch p2 of the fourth pattern portion 240 may be about 40 μm or less. In detail, the second pitch p2 of the fourth pattern portion may be 30 μm to 40 μm.

In this case, the second pitch of the fourth pattern portion 240 may be defined as a distance from one end of a fourth pattern portion to one end of another fourth pattern portion, which are adjacent to each other.

When the first pitch and/or the second pitch exceeds 60 μm, the overall size of the optical path control member may be increased by the third pattern portion 230 and the fourth pattern portion 240, and as the width of the pattern portion serving to block light is increased and the region through which light is transmitted is reduced, and accordingly, the overall brightness of the optical path control member may be deteriorated.

In addition, when the first pitch and/or the second pitch is less than 30 μm, the area supporting the pattern portion may be reduced, whereby the light blocking effect due to the patterns may be reduced, and the pattern portion may be easily damaged by an external impact, thereby deteriorating reliability.

Meanwhile, a difference in size between the first pitch and the second pitch may be about 5 μm to 30 μm. In detail, the difference in size between the first pitch and the second pitch may be 10 μm to 20 μm. When the first pitch and the second pitch are less than about 5 μm, a difference in amount of light transmitted through the first region 1A and the second region 2A becomes small, whereby it is difficult to control the amount of light transmitted for each region, and thus a control of the overall brightness may be difficult.

In addition, when the difference in size between the first pitch and the second pitch exceeds about 30 μm, the difference in the amount of light transmitted through the first region 1A and the second region 2A is rapid1y increased, whereby it may be difficult to control the light transmittance effectively in each region.

The third pattern portion 230 on the first region 1A may be disposed in an outer region of the optical path control member. In addition, the fourth pattern portion 240 on the second region 2A may be disposed in a central region of the optical path control member.

That is, when the optical path control member according to the embodiment is applied to a vehicle, the third pattern portion 230 may be disposed in the first region 1A defined as the signal portion, and the fourth pattern portion 240 may be disposed in the second region 2A defined as the display portion.

The third pattern portions 230 may be spaced apart from each other at a first distance d1. In addition, the fourth pattern portions 240 may be spaced apart from each other at a second distance d2.

The first distance d1 may be defined as a region in which the third pattern portions 230 are not disposed in the first region 1A. That is, the first distance d1 may be defined as a region through which light is transmitted in the first region 1A.

In addition, the second distance d2 may be defined as a region in which the fourth pattern portions 240 are not disposed in the second region 2A. That is, the second distance d2 may be defined as a region through which light is transmitted in the second region 2A.

The first distance d1 and the second distance d2 may be different from each other. In detail, a size of the first distance d1 may be larger than a size of the second distance d2.

For example, the first distance d1 may be about 30 μm to about 40 μm, and the second distance d2 may be about 25 μm to about 35 μm.

In the optical path control member according to the embodiment, the width of the pattern portion in the first region may be larger than the width of the pattern portion in the second region.

That is, a density of the pattern portion per unit area in the first region may be greater than a density of the pattern portion per unit area in the second region.

Accordingly, the light transmittance per unit area in the first region may be smaller than the light transmittance per unit area in the second region.

Accordingly, the overall light transmittance in the first region and the second region may be controlled. That is, in the second region in which transmission of the light source is partially obstructed, the light transmittance may be relatively increased, thereby improving visibility in the display region. In addition, in the first region, the light transmittance may be relatively reduced to improve the brightness uniformity in the first region and the second region.

Therefore, the optical path control member according to the embodiment may improve the brightness uniformity in the first and second regions without disposing additional shielding films while improving the visibility of the display region with the same amount of light.

Meanwhile, although not shown in the drawing, when an amount of light emitted from the first region 1A is smaller than an amount of light emitted from the second region 2A, a width of the third pattern portion may be smaller than a width of the fourth pattern portion. That is, in the first region of the signal portion in which the amount of light is small, the width of the pattern portion is reduced to increase the light transmittance, and in the second region of the display portion in which the amount of light is relatively large, the width of the pattern portion may be increased to reduce the light transmittance.

Accordingly, the brightness may be made uniform by allowing the user to recognize the same light transmittance as a whole by reducing the light transmittance in a portion in which the amount of light emitted is large and increasing the light transmittance in a portion in which the amount of light emitted is small.

Hereinafter, an optical path control member according to another second embodiment will be described with reference to FIGS. 21 to 24. In description of the optical path control member according to the other second embodiment, the description that is the same as or similar to that of the optical path control member according to the second embodiment described above will be omitted, and the same configurations are designated by the same reference numerals.

Referring to FIGS. 21 to 24, an optical path control member according to another embodiment may include a base substrate 100, a resin layer 150 disposed on the base substrate 100, an intaglio portion E1 formed on the resin layer 150, and a pattern portion disposed inside the intaglio portion E1.

Descriptions of the shape and the material of the base substrate 100 and the resin layer 150 are the same as or similar to those of the optical path control member according to the first embodiment described above, and thus the following description is omitted.

The optical path control member according to the other second embodiment may include a plurality of intaglio portions E1 having different distances. In addition, the optical path control member according to another embodiment may include a plurality of pattern portions having different distances.

That is, in the optical path control member according to another embodiment, the size of the pattern portion of the first region 1A and the second region 2A, that is, the width may be the same or similar, and the distance between the third pattern portion 230 and the fourth pattern portion 240 may be different from each other.

For example, the distance between the intaglio portions E1 may be changed while extending from one end to the other end of the resin layer 150. In detail, the distance between the intaglio portions E1 may be increased or decreased while extending from one end to the other end of the resin layer 150.

That is, the distance of the pattern portion disposed inside the intaglio portion E1 may also be increased or decreased while extending from one end to the other end of the resin layer 150.

For example, the base substrate 100 may include the first region 1A and the second region 2A. For example, the first region 1A may be defined as an outer region of the base substrate 100, and the second region 2A may be defined as a central region of the base substrate 100.

As described above, when the optical path control member according to the embodiment is applied to a vehicle, the first region 1A may be defined as a signal portion that displays a warning signal or the like, and the second region 2A may be defined as a display portion that displays a speed, an engine, a navigation system, and the like.

In this case, sizes of the first region 1A and the second region 2A may be the same. Alternatively, the sizes of the first region 1A and the second region 2A may be different.

For example, when the optical path control member according to the embodiment is applied to a vehicle, the size of the second region 2A defined as the display portion may be larger than the size of the first region 1A defined as the signal portion.

In addition, light sources of light emitted toward the first region 1A and the second region 2A may be different from each other. For example, light may be emitted by a light source such as an LED in the first region 1A, and light may be emitted by a display panel, that is, a light source such as an LCD or an OLED in the second region 2A.

In addition, the resin layer 150 disposed on the base substrate 100 may also include a region corresponding to the first region and a region corresponding to the second region.

The pattern portion may include a third pattern portion 230 disposed on the first region 1A and a fourth pattern portion 240 disposed on the second region 2A.

The third pattern portion 230 on the first region 1A may be disposed in an outer region of the optical path control member. In addition, the fourth pattern portion 240 on the second region 2A may be disposed in a central region of the optical path control member.

The third pattern portions 230 may have a first distance d1. In addition, the fourth pattern portions 240 may have a second distance d2.

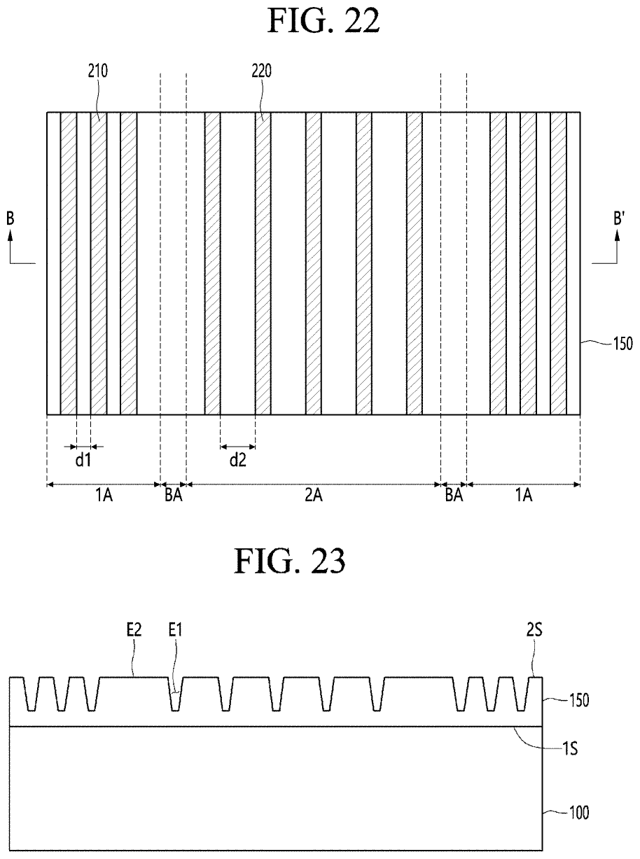

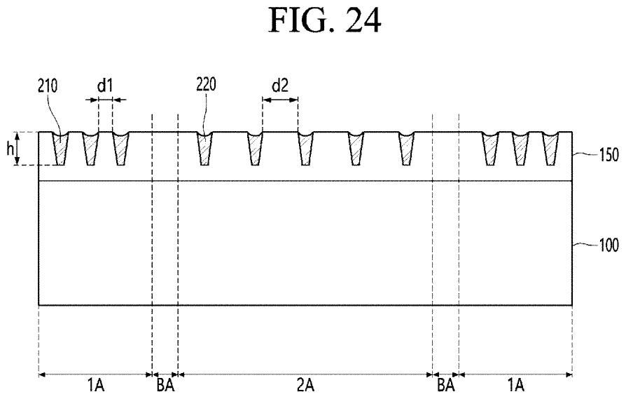

A size of the first distance d1 may be different from a size of the second distance d2. In detail, referring to FIGS. 22 and 24, the size of the first distance d1 may be smaller than the size of the second distance d2. That is, the distance between the third pattern portions 230 may be smaller than the distance between the fourth pattern portions 240.

Accordingly, in the first region 1A, a ratio of a region in which the pattern portion is disposed per unit area becomes small, and thus, an area of a region through which the light is transmitted may be smaller than the second region 2A.

In addition, in the second region 2A, a ratio of the region in which the pattern portion is disposed per unit area becomes small, and thus, the area of the region through which the light is transmitted may be larger than the first region 1A.

Accordingly, in the optical path control member, amounts of light transmitted per unit area in the first region 1A and the second region 2A may be different.

That is, a density of the pattern portion per unit area in the first region may be greater than a density of the pattern portion per unit area in the second region.

Accordingly, the light transmittance per unit area in the first region may be smaller than the light transmittance per unit area in the second region.

Accordingly, the overall light transmittance in the first region and the second region may be controlled. That is, in the second region in which transmission of the light source is partially obstructed, the light transmittance may be relatively increased, thereby improving visibility in the display region. In addition, in the first region, the light transmittance may be relatively reduced to improve the brightness uniformity in the first region and the second region.

Therefore, the optical path control member according to the embodiment may improve the brightness uniformity in the first and second regions without disposing additional shielding films while improving the visibility of the display region with the same amount of light.

Meanwhile, although not shown in the drawing, when an amount of light emitted from the first region 1A is smaller than an amount of light emitted from the second region 2A, a width of the third pattern portion may be larger than a width of the fourth pattern portion. That is, in the first region of the signal portion in which the amount of light is small, the distance of the pattern portion is increased to increase the light transmittance, and in the second region of the display portion in which the amount of light is relatively large, the width of the pattern portion may be decreased to reduce the light transmittance.

Accordingly, the brightness may be made uniform by allowing the user to recognize the same light transmittance as a whole by reducing the light transmittance in a portion in which the amount of light emitted is large and increasing the light transmittance in a portion in which the amount of light emitted is small.

The optical path control member according to the second embodiments may be efficiently applied in a display device that requires different light transmittance for each region.

For example, the optical path control member according to the second embodiment may be applied to a vehicle. For example, an instrument panel including a display portion for displaying a speed, an engine, a navigation system, and the like. and a signal portion for displaying a warning signal, may be displayed in front of the driver's seat of the vehicle.

In this case, the display portion for displaying a speed, an engine, a navigation system, and the like is a portion in which the user acquires information by visual recognition, and the signal portion is a portion in which the user operates, and thus the display portion may be required to have a relatively larger light transmittance than the signal portion.

Accordingly, when the light transmittance of the optical path control member applied to the display portion becomes smaller than that of the optical path control member applied to the signal portion, the visibility at the display portion may be deteriorated, and unnecessary light is transmitted to the signal portion, and thus the light efficiency may be lowered.

In addition, when light is emitted by the same type of light source in the display portion and the signal portion, the display portion may be required to have a larger amount of light than the signal portion. That is, the display portion may be required to have a larger light transmittance than the signal portion.

The optical path control member according to the second embodiment may be effectively applied to a display device that requires different light transmittances for each region as described above. That is, the visibility may be improved by the same amount of light emitted from a light source by increasing the light transmittance in a portion requiring high brightness and decreasing the light transmittance in a portion requiring relatively low brightness, so that the visibility and the light efficiency in each region may be improved.

That is, in a portion requiring larger brightness, the light transmittance may be increased by increasing the distance between the pattern portions or decreasing the width of the pattern portions to decrease the density of the pattern portion per unit area, and in a portion requiring smaller brightness, the light transmittance may be decreased by decreasing the distance between the pattern portions or increasing the width of the pattern portion to increase the density of the pattern portion per unit area.

That is, the optical path control member according to the second embodiments may control the light transmittance according to the use environment of the display device to which the optical path control member is applied by varying the distance or the width of the pattern portion for each region, and accordingly, it is possible to improve and control the visibility of the user in each region even without an additional light source or a light-shielding member.

In the foregoing description, only controlling the width and distance of the pattern portion in the first region and the second region has been described, but the embodiment is not limited thereto, and of course, the light transmittance may be controlled by controlling at least one of the width, the distance, and the pitch of the pattern portion.

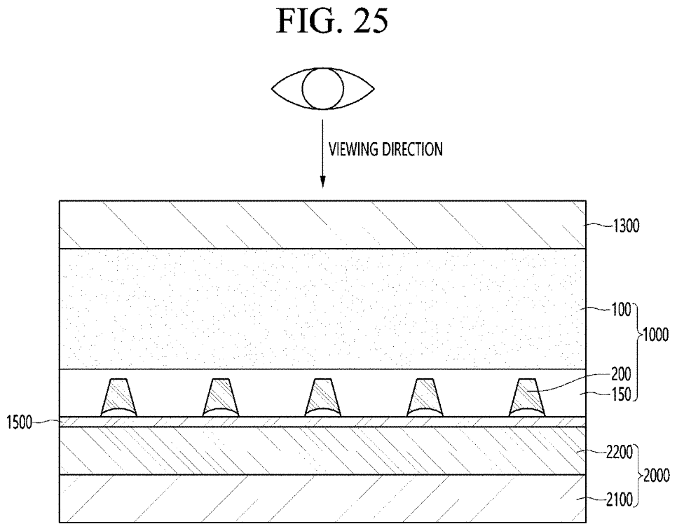

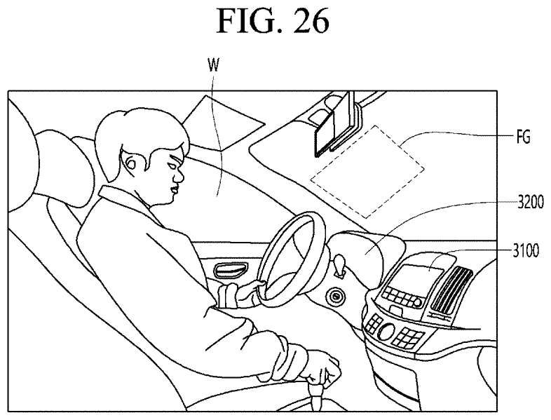

Hereinafter, referring to FIGS. 25 and 26, a display device to which an optical path control member according to an embodiment is applied will be described.

Referring to FIG. 25, an optical path control member 1000 according to an embodiment may be disposed on a display panel 2000.

The display panel and the optical path control member 1000 may be disposed to be adhered to each other. For example, the display panel and the optical path control member 1000 may be adhered to each other via an adhesive layer 1500. The adhesive layer 1500 may be transparent. For example, the adhesive layer 1500 may include an adhesive or an adhesive layer including an optical transparent adhesive material.

The adhesive layer 1500 may include a release film. Specifically, the adhesive layer may be disposed while covering the pattern portion on a resin layer 150 of the optical path control member, and when the adhesive layer adheres to the pattern layer or the display panel, after the release film is removed, the pattern layer, the optical path control member, and the display panel may be adhered to each other.

Accordingly, when the pattern portion is exposed to the outside by the adhesive layer 1500, a risk of breakage may be prevented. That is, the adhesive layer 1500 may be an adhesive layer and a protective layer.

The display panel 2000 may include a first substrate 2100 and a second substrate 2200. When the display panel 2000 is a liquid crystal display panel, the display panel 2000 may be formed in a structure in which a first substrate 2100 including a thin film transistor (TFT) and a pixel electrode and a second substrate 2200 including color filter layers are bonded with a liquid crystal layer interposed therebetween.

In addition, the display panel 2000 may be a liquid crystal display panel of a color filter on transistor (COT) structure in which a thin film transistor, a color filter, and a black matrix are formed at a first substrate 2100 and a second substrate 2200 is bonded to the first substrate 2100 with a liquid crystal layer interposed therebetween. That is, a thin film transistor may be formed on the first substrate 2100, a protective film may be formed on the thin film transistor, and a color filter layer may be formed on the protective film. In addition, a pixel electrode in contact with the thin film transistor may be formed on the first substrate 2100. At this point, in order to improve an aperture ratio and simplify a masking process, a black matrix may be omitted, and a common electrode may be formed to function as the black matrix.

In addition, when the display panel 2000 is a liquid crystal display panel, the display device may further include a backlight unit providing light from a rear surface of the display panel 2000.

Alternatively, when the display panel 2000 is an organic electroluminescence display panel, the display panel 2000 may include a self-luminous element that does not require a separate light source. In the display panel 2000, a thin film transistor may be formed on the first substrate 2100, and an organic light emitting element in contact with the thin film transistor may be formed. The organic light emitting element may include an anode, a cathode, and an organic light emitting layer formed between the anode and the cathode. Further, a second substrate 2200 configured to function as an encapsulation substrate for encapsulation may further be included on the organic light emitting element.

Furthermore, although not shown in drawings, a polarizing plate may be further disposed between the optical path control member 1000 and the display panel 2000. The polarizing plate may be a linear polarizing plate or an external light reflection preventive polarizing plate. For example, when the display panel 2000 is a liquid crystal display panel, the polarizing plate may be the linear polarizing plate. Further, when the display panel 2000 is an organic electroluminescence display panel, the polarizing plate may be the external light reflection preventive polarizing plate.

In addition, an additional functional layer 1300 such as an anti-reflection layer, an anti-glare, or the like may be further disposed on the optical path control member 1000. Specifically, the functional layer 1300 may be adhered to one surface of the base substrate 100 of the optical path control member. Although not shown in drawings, the functional layer 1300 may be adhered to the base 100 of the optical path control member via an adhesive layer. In addition, a release film for protecting the functional layer may be further disposed on the functional layer 1300.

Further, a touch panel may be further disposed between the display panel and the optical path control member.

Although it is shown in the drawings that the optical path control member is disposed at an upper portion of the display panel, but the embodiment is not limited thereto, and the optical path control member may be disposed at various positions such as a position in which light is adjustable, that is, a lower portion of the display panel, between an upper substrate and a lower substrate of the display panel, or the like.

Referring to FIG. 26, an optical path control member according to an embodiment may be applied to a vehicle.

Referring to FIG. 26, a display device to which the optical path control member according to the embodiment is applied may be disposed inside a vehicle.

For example, the display device according to the embodiment may display a video confirming information of the vehicle and a movement route of the vehicle. The display device 3100 may be disposed between a driver seat and a passenger seat of the vehicle.

In addition, the optical path control member according to the embodiment may be applied to a dashboard 3200 that displays a speed, an engine, an alarm signal, and the like of the vehicle.

Furthermore, the optical path control member according to the embodiment may be applied to a windshield (FG) of the vehicle or right and left window glasses (W).

The characteristics, structures, effects, and the like described in the above-described embodiments are included in at least one embodiment of the present invention, but are not limited to only one embodiment. Furthermore, the characteristic, structure, and effect illustrated in each embodiment may be combined or modified for other embodiments by a person skilled in the art. Accordingly, it is to be understood that such combination and modification are included in the scope of the present invention.

The above description of the embodiments is merely examples and does not limit the present invention. It would be apparent to those of ordinary skill in the art that the present invention may be easily embodied in many different forms without changing the technical idea or essential features thereof. For example, elements of the exemplary embodiments described herein may be modified and realized. Also, it should be construed that differences related to such changes and applications are included in the scope of the present invention defined in the appended claims.

1. An optical path control member coupled to an other member comprising:
a base substrate;
a resin layer disposed on the base substrate and including a plurality of intaglio portions spaced from each other; and
a plurality of pattern portions disposed inside the plurality of intaglio portions and spaced from each other,
wherein a pitch of the plurality of pattern portions is smaller than a pitch of a pattern of the other member, and
the pitch of the plurality of pattern portions is 30 μm or less.

2. The optical path control member of claim 1, wherein the pattern portions include a first pattern portion and a second pattern portion, and
the first pattern portion and the second pattern portion are formed in different shapes.

3. The optical path control member of claim 2, wherein the second pattern portion includes a plurality of short-circuited portions.

4. The optical path control member of claim 3, wherein a width of the short-circuited portion is 1 μm to 50 μm.

5. The optical path control member of claim 3, wherein a ratio of the second pattern portion to the entire pattern portion portions including the first pattern portion and the second pattern portion is greater than a ratio of the first pattern portion to the entire pattern portions.

6. The optical path control member of claim 1, wherein the pattern portions include a first sub pattern portion extending in a first direction and a second sub pattern portion extending in a second direction different from the first direction.

7. An optical path control member comprising:
a base substrate comprising a first region and a second region;
a resin layer disposed on the base substrate and including a plurality of intaglio portions spaced apart from each other; and
a plurality of pattern portions disposed in the plurality of intaglio portions and spaced apart from each other,
wherein the first region is defined as an outer region of the base substrate,
the second region is defined as a central region of the base substrate,
the pattern portions include a plurality of first pattern portions disposed on the first region and second pattern portions disposed on the second region, and
a first pitch of the first pattern portions is larger than a second pitch of the second pattern portions.

8. The optical path control member of claim 7, wherein a width of the first pattern portions is larger than a width of the second pattern portions.

9. The optical path control member of claim 7, wherein the first region is defined as a signal region, and
the second region is defined as a display region of the base substrate.

10. A display device comprising:
a display panel; and
an optical path control member disposed on the display panel,
wherein the optical path control member comprises:
a resin layer disposed on the display panel and including a plurality of intaglio portions spaced apart from each other and a plurality of embossed portions;
a plurality of pattern portions disposed in the plurality of intaglio portions and spaced apart from each other; and
a base substrate disposed on the resin layer,
wherein a pitch of the plurality of pattern portions is 30 μm or less, and
a pitch of the pixel pattern is 120 μm to 145 μm.

11. The optical path control member of claim 1, wherein the pitch of the pattern of the other member is 100 μm to 150 μm.

12. The optical path control member of claim 1, wherein the other member includes a display panel.

13. The optical path control member of claim 1, wherein a height of the pattern portion is 20 μm to 120 μm.

14. The optical path control member of claim 1, wherein the pattern portions are disposed at a height of 90% or more to less than 100% of the maximum depth of the intaglio portions.

15. The optical path control member of claim 3, wherein the plurality of short-circuited portions have different sizes.

16. The optical path control member of claim 1, wherein a difference between the first pitch and the second pitch is 5 μm to 30 μm.

17. The optical path control member of claim 8, wherein a difference between the width of the first pattern portions and the width of the second pattern portions is 1 μm to 15 μm.

18. The optical path control member of claim 2, wherein a first distance of the first pattern portion is larger than a second distance of the second pattern portion.

19. The optical path control member of claim 7, wherein a density of the pattern portions per unit area in the first region is greater than a density of the pattern portions per unit area in the second region.

20. The display device of claim 10, wherein the display panel and the optical path control member satisfy a value defined by the following equation of less than 2,500:
$$λ = {\vert \frac{k}{{p}_{1}} - \frac{m}{{p}_{2}} \vert}^{- 1} \qquad [ Equation ]$$
(wherein P1 is a pitch of the pattern portion of the optical path control member, P2 is a pitch of the pixel pattern of the display panel, k is a number of pattern portions of the optical path control member, and m is a number of pixel patterns of the display panel).
